(19) United States
(12) Patent Application Publication
(10) Pub. No.: US 2004/0187794 A1
(43) Pub. Date: Sep. 30, 2004

(54) Process for producing artificial rawhide

(76) Inventor: Tatsuji Nakata, Osaka-shi (JP)

Correspondence Address: MERCHANT & GOULD PC, P.O. BOX 2903, MINNEAPOLIS, MN, 55402-0903, US

(21) Appl. No.: 10/484,538

(22) PCT Filed: Aug. 1, 2002
(86) PCT No.: PCT/JP02/07849

(30) Foreign Application Priority Data
Aug. 2, 2001 (JP) 2001-235261

(51) Int. Cl. A23K 1/18; A01K 29/00

(52) U.S. Cl. 119/709

(57) ABSTRACT

A process whereby artificial rawhide comparable in qualities to natural rawhide can be produced. After pre-treatments such as washing with water, liming, bleaching, etc., rawhide is roughly cut into pieces (about 10 cm×10 cm) and then further finely cut with the use of a chopper and a micro-cutter to thereby prepare collagen fibers. Next, water, a collagen fiber powder and gelatin are added thereto to give a sol or a gel having a moisture content of 60 wt % to 80 wt %. Then it is extruded into a sheet, using a screw extruder at 30° C. or below and dried, thereby giving artificial rawhide. This artificial rawhide in the form of a sheet is cut into strips in a predetermined size. Then, each strip is rolled in the width direction and tied in the length direction. Thus, a bone-shape chewing gum for dogs can be obtained.

### TECHNICAL FIELD

The present invention relates to a process for producing artificial rawhide, artificial rawhide obtained through the process, a process for producing a dog chew, and a dog chew obtained through the process.

### BACKGROUND ART

Dog chews (products for dogs to chew on) have been used for keeping dogs' teeth and gums healthy. A dog chew can be produced by cutting bovine rawhide into strips in a predetermined size, rolling each strip in the width direction, knotting the strip at the both ends in the longitudinal direction so as to shape it like a bone, and drying the strip. Dried rawhide has a suitable hardness, and its toughness for chewing will satisfy dogs. However, scraps formed due to a step of cutting bovine rawhide into strips in a predetermined size have been discarded. Discarding such scraps is not preferable in light of the cost and effective utilization of resources. U.S. Pat. No. 5,635,237 discloses a technique of producing artificial rawhide by extruding natural rawhide by using a double-shaft extruder. However, artificial rawhide produced by the technique disclosed in the publication is inferior in comparison to natural rawhide. Namely, the artificial rawhide does not have comparable qualities to the natural one.

### DISCLOSURE OF INVENTION

An object of the present invention is to provide a process for producing artificial rawhide, and the process is cost-effective, contributes to effective use of resources, and provides artificial rawhide comparable in qualities to natural rawhide.

For achieving the above object, a process for producing artificial rawhide according to the present invention includes: extruding a sol/gel of collagen fibers prepared by mixing collagen fibers with a binder and water, under a temperature condition to avoid degeneration of the collagen fibers; and drying the extruded sol/gel.

In the process, artificial rawhide having comparable qualities to natural rawhide can be produced. Therefore, a dog chew made of this artificial rawhide will be comparable to one made of natural rawhide in qualities such as appearance, hardness, nutrition and safety. In addition, natural hides such as bovine hides can be used effectively.

### BRIEF DESCRIPTION OF DRAWINGS

FIGS. 1(A), 1(B) and 1(C) are diagrams showing an example of a process for producing a dog chew from artificial rawhide.

### PREFERRED EMBODIMENT OF THE INVENTION

In a process according to the present invention, it is preferable that a sol/gel of collagen fibers is determined to have a moisture content of 60 wt % to 80 wt %. When the moisture content is as high as mentioned above, heat generation at a time of an extruding step can be prevented and degeneration of the collagen fibers can be suppressed more effectively. It is also preferable in the process that the temperature for the extruding step is not higher than 30° C. Needless to say, it is preferable that the other steps are carried out at low temperature, i.e., not higher than 30° C. At the low temperature, degeneration of the collagen fibers can be prevented more effectively. Though there is no specific lower limitation, it is preferable that the temperature is higher than a freezing point, since production may be hampered when the sol/gel of collagen fibers gets frozen. It is preferable that the collagen fibers are obtained by finely cutting natural rawhide. For facilitating the subsequent processes, it is preferable that the sol/gel of collagen fibers is extruded into a sheet in the extruding step. The sheet-shape sol/gel is dried, cut into strips in a predetermined size, and each strip is rolled in the width direction and knotted at the both ends in the longitudinal direction to be shaped like a bone, thereby providing a dog chew. Alternatively, the drying step can be carried out at any point after the extruding step without any specific limitations. For example, the sheet can be cut into strips before a drying step.

In the process according to the present invention, it is preferable that the binder is a collagen fiber powder and/or gelatin. Since the collagen fiber powder and gelatin are components of rawhide, substantially no problems in safety will occur, and thus the artificial rawhide made by using the materials can resemble natural rawhide closely. In the present invention, it is also preferable that the blend rate of the binder is set to be a range of 5 to 50 parts by weight, or more preferably, 30 parts by weight, with respect to collagen fibers of 100 parts by weight.

An example of a process for producing artificial rawhide of the present invention will be described below.

### Preparation of Rawhide

First, a raw skin (material of rawhide) is prepared. The skin can be selected, for example, from a cattle skin, a horse skin, a goatskin, and a pig skin. Among them, cattle skin is preferred. The term ‘hide’ denotes a thick, large and heavy skin weighing at least 25 pounds (about 11.453 kg) taken from an adult cattle or the like. The raw skin is usually salted or dried for preventing putrefaction.

Next, the raw skin is washed with water in order to remove blood or taints adhering to the skin. The washing is carried out, for example, for 48 to 96 hours, or preferably for about 72 hours, using a paddle, a drum, a wattle or the like. In the washing step, a detergent or an antiseptic can be used. For example, the pH in the washing step is 7 to 8.

Next, the raw skin is soaked in milk of lime in order to swell the skin with alkali and disentangle the collagen fibers of the skin, and at the same time, to decompose and remove hair, fat, and an epidermal layer (this step is called liming). For the equipment, a paddle, a drum or the like is used. Calcium hydroxide is used as a chemical reagent, and in addition, sodium sulfate, sodium hydroxide or the like also can be used. A specialized surfactant can be used as well. For example, the pH during the liming step is 12 to 13. The addition amount of the calcium hydroxide or the like is adjusted for providing the desired pH value. Time for the treatment is, for example, 72 hours to 120 hours, or preferably, about 96 hours. Preferably, this liming is followed by washing with water.

Next, bleaching is carried out by using a bleaching agent. The bleaching agent may be, for example, sodium sulfite, sodium hyposulfite, and hydrogen peroxide. Among them, sodium sulfite is used preferably. Though the use amount of the bleaching agent will be adjusted suitably depending on the type, amount or the like of the raw skin, for example, a preferable range for the sodium sulfite is 2 parts to 15 parts by weight, or preferably 2 parts to 6 parts by weight, with respect to a raw skin of 100 parts by weight. Time for the treatment is, for example, 24 hours to 120 hours, or preferably, about 48 hours. Equipment for use may be, for example, a paddle, a drum or the like.

After the bleaching, the pH of the raw skin is adjusted to a range of 6 to 8, or preferably to pH 7. Chemical reagents used for the pH adjustment may be, for example, sulfuric acid, hydrochloric acid, and lactic acid. After the pH adjustment, washing is carried out again to prepare rawhide.

### Preparation of Collagen Fibers

The rawhide is cut roughly into pieces. Each piece is, for example, 2 cm×5cm, or preferably, about 3 cm×3 cm. Equipment used for the rough cutting may be, for example, a food cutter and a chopper. Next, the roughly-cut rawhide is subjected to a chopper, and further to a micro-cutter so as to be finely chopped. The chopper has a diameter of; for example, 30 mm to 150 mm, or preferably, 100 mm. In this manner, collagen fibers can be prepared. The above-mentioned method of preparing collagen fibers from rawhide through a mechanical decomposition can be replaced by a method of preparing collagen fibers by decomposing rawhide with the help of an enzyme. The enzyme may be, for example, collagenase.

### Preparation of a Sol/Gel of Collagen Fibers

The collagen fibers are blended with a binder and water and then stir-mixed so as to prepare a sol/gel of collagen fibers. For the binder, a collagen fiber powder and/or gelatin is used preferably as described above, though other binders can be used as well. The collagen fiber powder can be homemade. For example, it can be prepared by drying and then pulverizing collagen fibers, and vice versa. The collagen fiber powder is not limited to a dried one. The blend rate of the collagen fiber powder is, for example, 5 parts to 50 parts by weight, or preferably 30 parts by weight with respect to the collagen fibers of 100 parts by weight. The blend rate of gelatin is, for example, 1 part to 30 parts by weight, or preferably 3 parts by weight with respect to the collagen fibers of 100 parts by weight. The moisture content of the sol/gel is preferably 60 wt % to 80 wt % as mentioned above, or more preferably, 65 wt %. It is preferable that the stir-mixing is carried out using a silent cutter. Time for the treatment is, for example, 5 minutes to 30 minutes. The temperature at the time of the stir-mixing is, for example, −5° C. to 20° C., or preferably, 0° C. to 5° C.

### Extrusion

Next, the sol/gel of collagen fibers is extruded for shaping. A screw extruder is preferred for the extruding step, and it can be either a single- or double-screw. The temperature during the extrusion is, for example, 5° C. to 30° C., or preferably, about 10° C. A sheet is preferred for the shape provided by the extruding step. The sheet has a thickness of, for example, 1 mm to 15 mm, or preferably, about 5 mm. For providing a predetermined thickness, an additional sheet of the sol/gel can be laminated on a sheet that is extruded previously. The extrusion is dried to provide a desired artificial rawhide. The drying is carried out at temperature in a range of 0° C. to 60° C., or preferably, at about 40° C. Though the drying degree is determined suitably depending on the use of the artificial rawhide, artificial rawhide used for a dog chew can be controlled to have a suitable hardness. The thus obtained rawhide is comparable in qualities to natural rawhide. It is preferable that the above-mentioned steps as well as the extrusion are carried out at low temperature not causing degeneration of the collagen fibers, e.g., in a range of 5° C. to 30° C.

### Production of Dog Chew

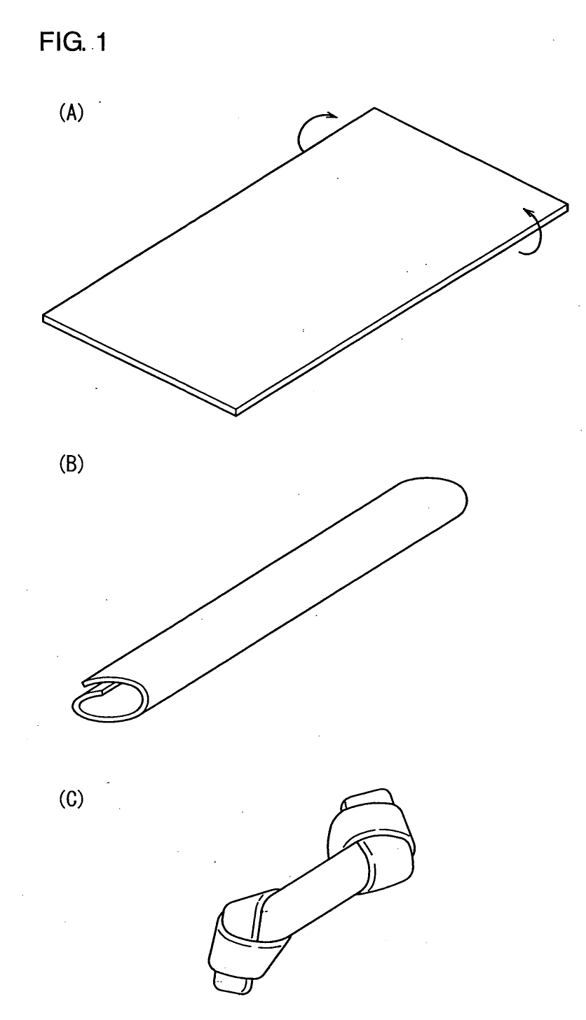

For producing a dog chew, the sheet that has been dried for allowing bending is cut into strips in a predetermined size as shown in FIG. 1(A). The size is determined suitably depending on the types of dogs such as large-size dogs, medium-size dogs and small-size dogs,.or depending on the ages, i.e., puppies or adult dogs. Next, as shown in FIG. 1(B), each strip is rolled in the width direction, flattened by pressing, and shaped like a bone by knotting at the both ends in the longitudinal direction (FIG. 1(C)), thereby providing a dog chew. The bone-shaped chew can be dried further under the above-mentioned condition until a predetermined hardness is achieved. The thus formed dog chew is substantially comparable in qualities to a chew of natural rawhide, and there is no substantial problem in the safety.

### EXAMPLE

A raw skin (natural bovine rawhide) of 6 tons was introduced into a paddle, and washed with water for about 5 hours. With respect to this raw skin, calcium hydroxide of about 3 wt % and sodium hydroxide of 1 wt % were added, and then liming was carried out for 24 hours, using the paddle. Later, the raw skin was washed with water for 8 hours and bleached at pH 11 with sodium sulfite. Then, the pH was adjusted to 6-7 over a period of 48 hours, and the skin was washed with water for 24 hours. The thus obtained rawhide was cut roughly into pieces of about 10 cm×10 cm by using a chopper, and subsequently subjected to a chopper whose diameter was 3 mm. The rawhide was chopped further with a micro-cutter so as to obtain collagen fibers. 250 kg of collagen fibers was blended with 2 wt % (5 kg) of a homemade collagen fiber powder and 3 wt % (7.5 kg) of a 10 wt % concentration of gelatin sol (trade name: C-501 supplied by Nitta Gelatin Inc.) of, and stir-mixed by using a silent cutter at 5° C. for 10 minutes, thereby providing a sol/gel of collagen fibers. The sol/gel of collagen fibers had a moisture content of 68 wt %. The sol/gel of collagen fibers was extruded on a belt conveyor through a single-screw extruder under a temperature condition of 10° C. in order to form a sheet having a thickness of about 5 mm. On this sheet, the collagen fibers were extruded further to form another sheet having a thickness of about 5 mm, thereby a sheet having a thickness of about 10 mm was obtained. This sheet was dried to have hardness for allowing a bending process (drying temperature: 40° C.), and cut into strips. Each strip was rolled in the width direction, flattened by pressing, and as shown in FIG. 1(C), the strip was knotted at the both ends in the longitudinal direction to be shaped like a bone, and dried to have predetermined hardness, thereby a dog chew was produced.

### Industrial Applicability

As described above, the process according to the present invention contributes to provide artificial rawhide being comparable in qualities to natural rawhide, and to reduce rawhide scraps that are generated during a process for producing a dog chew.

1. A process for producing artificial rawhide, the process comprising: extruding a sol or a gel of collagen fibers prepared by mixing collagen fibers with a binder and water, under a temperature condition to avoid degeneration of the collagen fibers; and drying the extruded sol or gel.

2. The process according to claim 1, wherein the sol or the gel of collagen fibers has a moisture content of 60 wt % to 80 wt %.

3. The process according to claim 1, wherein the extrusion is carried out at temperature not higher than 30° C.

4. The process according to claim 1, wherein the binder is at least one selected from the group consisting of a collagen fiber powder and gelatin.

5. The process according to claim 1, wherein the binder is blended at a rate of 5 parts to 50 parts by weight with respect to the collagen fibers of 100 parts by weight.

6. The process according to claim 1, wherein the collagen fibers are obtained by chopping finely natural rawhide.

7. The process according to claim 1, wherein the sol or the gel of collagen fibers are extruded to form a sheet.

8. An artificial rawhide produced by the process according to claim 1.

9. A process for producing a dog chew, the process comprising: cutting a sheet obtained by the process according to claim 7 into strips in a predetermined size, rolling each strip in the width direction, and knotting the strip at the both ends in the longitudinal direction to be shaped like a bone.

10. A dog chew produced by the process according to claim 9.
